(19) United States
(12) Patent Application Publication
(10) Pub. No.: US 2006/0197775 A1
(43) Pub. Date: Sep. 7, 2006

(54) Virtual monitor system having lab-quality color accuracy

(76) Inventor: Michael Neal, Moosic, PA (US)

Correspondence Address: Lawrence P. Zale, 334 South Franklin Street, Wilkes-Barre, PA, 18702, US

(21) Appl. No.: 11/368,989

(22) Filed: Mar. 6, 2006

Related U.S. Application Data
(60) Provisional application No. 60/659,605, filed on Mar. 7, 2005.

(51) Int. Cl. G09G 5/02

(52) U.S. Cl. 345/589

(57) ABSTRACT

The present invention provides a simple interactive device intended to be used by the customer for acquiring an image of the customer, interactively allowing the customer to try on virtual shades of lipstick, makeup, color contacts, hair color, and/or apparel at the same time to change their appearance. The present invention takes into account the deviations due to the input devices and the output devices thereby resulting in laboratory quality color accuracy and very realistic images. Since it is so accurate, customers may rely on the present invention instead of “trying on” the products. This allows a customer to view many different colors and color schemes in a fraction of the time, while freeing up store employees. The present invention may also display several images simultaneously to allow a customer to efficiently determine the best color scheme or look requiring minimal employee input.

### CROSS REFERENCE TO RELATED APPLICATIONS

This application is related to, and claims priority from U.S. patent application Ser. No. 10/938,868 “Method of Interactive System for Previewing and Selecting Eyeware” by Dr. Michael R. Neal filed Sep. 13, 2004. This application is also related to, and claims priority from U.S. Provisional Patent Application 60/659,605 “VIRTUAL MONITOR SYSTEM HAVING LAB-QUALITY COLOR ACCURACY” by Dr. Michael R. Neal filed Mar. 7, 2005.

### FIELD OF THE INVENTION

The present invention relates to an interactive device which displays computer enhanced images, and more specifically to an interactive device which displays computer color-accurate enhanced images simulating a user wearing various products.

### BACKGROUND OF THE INVENTION

There are several interactive computer systems generally known in the art to enable users to virtually view and select products. One such example exists in hair salons. A customer has their picture taken and displayed on a computer screen. The image is then computer enhanced to display different hair styles allowing the customer to select which hair style they prefer. This allows the consumer to view the hair design as it would look on them, without having to actually have their hair cut or styled.

A problem with the device described above, and similar devices is that these devices are typically not intuitively obvious to use and are typically operated by an employee, taking up the employee's time.

These images are also crude representations of the user and typically do not properly display the correct colors or overlay the computer enhancements. These do not give realistic representations, thereby distorting their color, thereby limiting their accuracy.

Typically when customers are shopping they would like an indication of how various products such as cosmetics, hair coloring, apparel, hats, jewelry, glasses, colored contacts etc. would look on them. Typically the process of trying on clothes, putting on makeup or glasses becomes time consuming, or sometimes is not possible (as in coloring your hair). Therefore, a system which would take a picture of the customer, and add overlays of various products and coloring would be useful, both to the customer and to the employees.

Currently there is a need for a device which may be easily operated by a customer, and provide an accurate image and colors of a customer wearing a product.

### SUMMARY OF THE INVENTION

The present invention may be embodied as a method of providing a color accurate enhanced image of a user.

The environment is darkened and the only lighting used is specially designed lighting having a spectrum that most closely resembles that of daylight. This minimizes the color distortion introduced.

An input profile of an input device intended to be used is determined indicating the color distortion introduced by the input device and the lighting.

An image is acquired using the input device in a controlled lighting environment.

The color spectrum of at least one location of the acquired image is modified according to the input profile to create a workspace image.

Features, such as lips, hair or skin of the image are interactively selected by the user to modify their colors.

An output profile of an output device, such as a monitor, intended to display the workspace image, is calculated.

The spectrum of the workspace image is adjusted according to the output profile to result in an adjusted image; and

The adjusted image is displayed on the output device to the user to result in an image with substantially improved color accuracy relative to prior art devices.

### BRIEF DESCRIPTION OF THE DRAWINGS

A complete understanding of the present invention may be obtained by reference to the accompanying drawings, when considered in conjunction with the subsequent detailed description, in which:

FIG. 1 is a perspective view illustrating a system compatible with the present invention.

FIG. 2 is a graph showing the spectral output of daylight vs. the SoLux™ light.

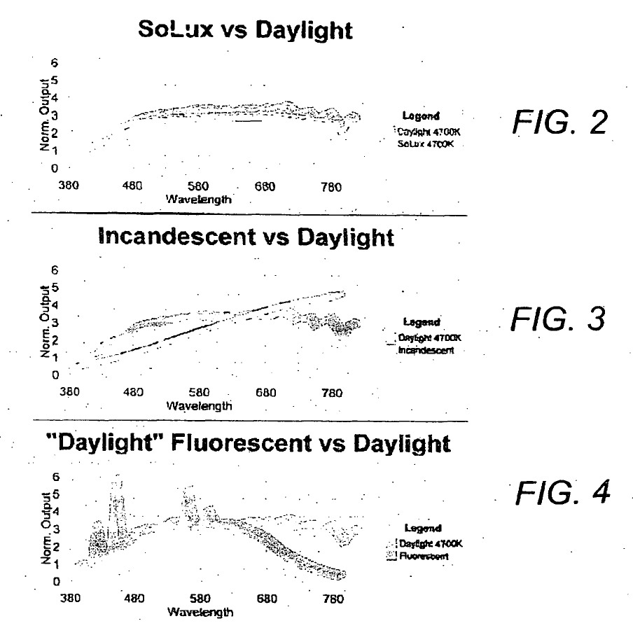

FIG. 3 is a graph showing the spectral output of daylight vs. incandescent light.

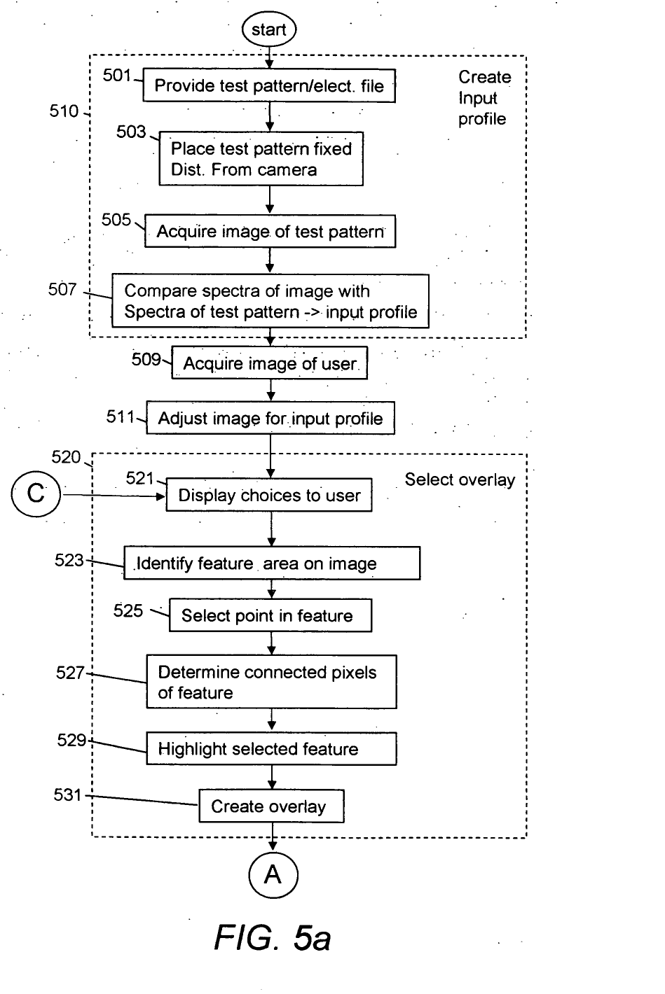

FIG. 4 is a graph showing the spectral output of daylight vs. fluorescent light.

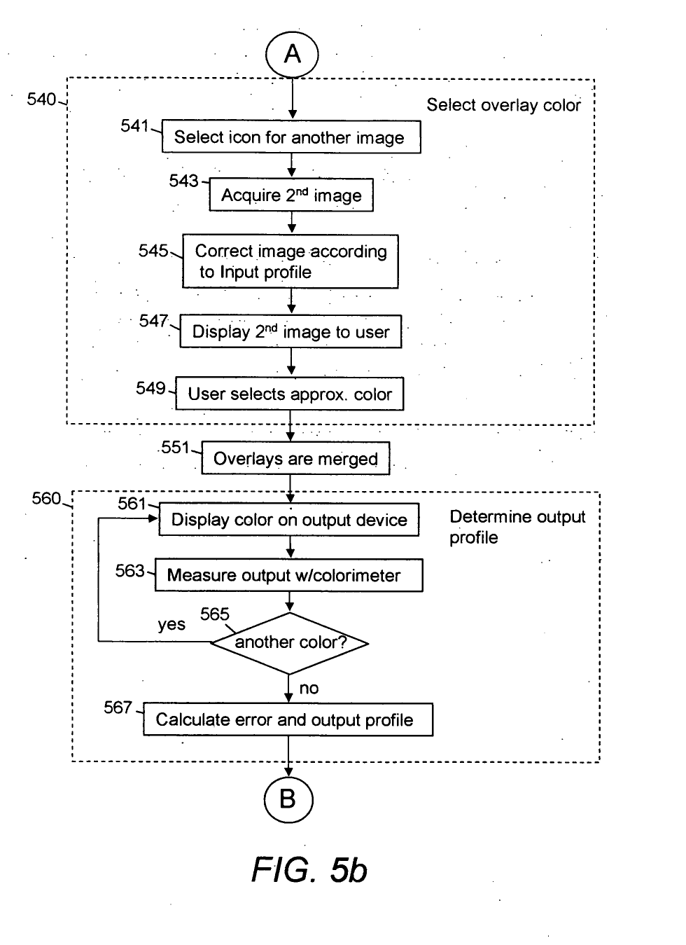

FIGS. 5a, 5b and 5c together are a flowchart illustrating the operation of a method according to the present invention.

FIG. 6 is a screen shot of monitor 11 shown having two images 610 and 620 of user 2 displayed side by side.

### DETAILED DESCRIPTION OF THE PREFERRED EMBODIMENT

Color Basics

The actual color of an object is a mixture of light rays of various visible light frequencies, with each frequency having a brightness or amplitude (a “spectrum”). Therefore, the color of an object at a specific point may accurately be described by its spectrum at that point.

Input Devices

Light is attenuated as it passes through various materials. Light waves at different frequencies are attenuated in different amounts as they pass through the same material. Therefore, light passing through lenses of a camera, or through the glass of a scanner attenuates some frequencies more than others. A measure of the attenuation over a visible range is defined as a light absorption profile.

Also, solid state devices which convert light into electric currents have a sensitivity which varies by the frequency of the light. The light sensors of a digital camera and scanner may have greater sensitivity to some frequencies, providing a strong signal when receiving these frequencies; however, it may be less sensitive when receiving other frequencies, producing a weaker electric signal. The sensor response over a range of visible light frequencies may be described by a sensor profile.

Light may also be reflected from mirrors which may distort the resulting amplitudes. These may also be described by a profile.

Similarly, light may pass through or reflect off of other surfaces in its path which could alter its intensities across the visible frequency band.

All of the elements which affect the resulting spectrum of the light should be taken into account to more accurately recover the original light spectrum.

Lighting

The ambient lighting present during the acquisition of an image affects the color spectra of the image. Lights illuminate with a spectral profile specific to each light. For example, if a light exhibits considerably amplified yellow frequencies relative to the remainder of the spectrum, it will cause an image acquired using this light to have amplified yellow frequencies as compared with the actual object.

In order to correct for the lighting profile, the present invention uses light which mimics the spectrum of daylight such as the specially designed SoLux™ light bulbs by Tailored Lighting, Inc. However, it is not possible to exactly replicate the spectrum of daylight; the lights influence the spectrum of an acquired image. These effects should also be taken into account.

A more complete description of the lighting spectra is provided at the website http://www.soluxtli.com/ hereby incorporated by reference as if set forth in its entirety herein.

Monitors

Synthetic devices which display images synthesize colors and hence images by trying to accurately reproduce these spectra at all locations of the image. CRT monitors create light with several different phosphors on their screen which illuminate when they are hit by a cathode ray. Each phosphor has a specific characteristic illumination spectrum. These phosphors are chosen to produce most of its illumination in a narrow range of the spectrum, for example a red spectrum range. Therefore, the object is to differentially illuminate each of the several phosphors to mix and provide a composite spectrum which most accurately represents the target color spectrum at a given point in the image. This is reproduced for all points (pixels) in the image.

Similarly, a liquid crystal display unit employs several different types of liquid crystals each which have characteristic illumination spectra. These are differentially illuminated to approximate a color at each screen location.

Since the monitors approximate the color using the tools (phosphors and liquid crystals) they have, they do not provide an exact reproduction of the original color. Therefore, it is possible to determine the characteristic output of each specific monitor to potentially correct for its imperfections.

Calibration of the Monitor

One way to calibrate a monitor is to provide the computer driving the monitor with an image having a known spectrum, display the spectrum and use a device to read the output of the monitor. The computer compares the readings to an intended spectrum to determine how much error is produced by the monitor. This results in a monitor profile.

The computer driving the image to the monitor typically has no information as to the type of monitor or its characteristic monitor profile. The signal is generated which is not adjusted to take into account the color inaccuracies of the monitor. The signal sent to the monitor is an internal or workspace representation of the signal, and has no color corrections built into it. Therefore, even if the colors in the computer are accurately represented; the color output of the monitor will be inaccurate based due to the color inconsistencies introduced by the monitor, according to the monitor profile.

Correction of Monitor Output

Therefore, using the monitor profile, the spectral frequencies where the monitor decreases the amplitude by an attenuation factor in the monitor profile, theoretically will be increased by that attenuation factor. Similarly, the spectral band where the monitor increases the amplitude by an amplification factor as per the monitor profile, will be attenuated by that amplification factor.

This corrected signal is then converted into an appropriate monitor signal (such as an RGB, composite video, etc) which is then displayed showing a more accurate representation of color.

Printers Similarly, printers using several different colors of ink, the most common being cyan, magenta, yellow, and black each having a specific color spectrum, may be mixed to approximate the target color.

Theoretically, many different colors of ink having their characteristic spectra may be combined to approximate a target color with each with varying degrees of accuracy.

Implementation

The present invention is such a device which is easy to operate and frees up the employees allowing them to take care of other tasks. It also allows the customer to view a larger number of products in a non-pressured environment. This device however must be very intuitive and provide accurate images, or its value will be significantly diminished.

Referring now to the several drawing figures in which identical elements are numbered identically throughout, a description of the preferred embodiment of the present invention will be provided. The preferred embodiment of the invention is described for illustrative purposes, it being understood that the invention may be embodied in other forms not specifically shown in the drawings or described hereinafter.

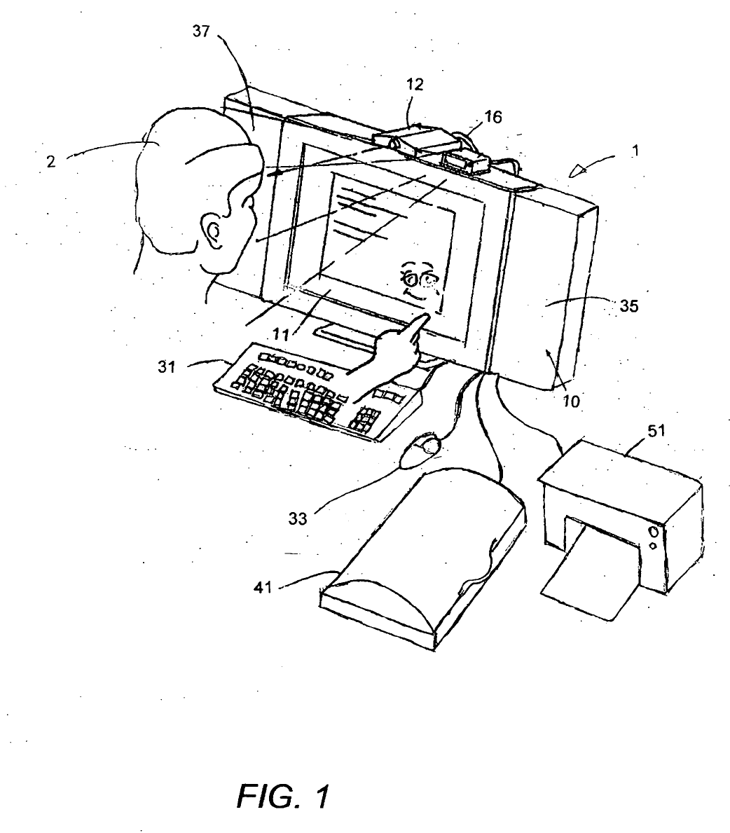

Referring now in detail to the drawings, FIG. 1 shows a virtual monitor system 1 having lab quality color accuracy according to one embodiment of the present invention. This includes a computer 10 with a digital camera 12 attached thereto. In the preferred embodiment, the computer 10 includes all the components of a typical computer system including a processor, memory storage devices and monitor 11. The computer 10 also includes data input/output ports, such as a CD-ROM drive and serial and USB ports for connection to other devices. Additionally, monitor 11 of the computer 10 may be a touch screen display, through which the user can input data and/or make selections by touching the screen. Alternatively, a keyboard 31 and mouse 33 may be used for user input.

In the preferred embodiment shown in FIG. 1, the camera 12 includes a Velcro™ attachment on the underside of its housing and is secured to the computer 10 via a corresponding Velcro™ attachment located thereon. The camera 12 is connected to the computer 10 by data cable 16, as is well known in the art.

Typically, the computer 10, will be set-up at a point of sale, such as an office of an eye care professional, a cosmetic counter, or apparel department, etc. where it would be useful to simulate products being used or worn by a user.

It should also be understood that the exemplary embodiments shown here are for illustrative purposes only, and are not meant to limit the scope of the invention. In particular, the wording, labels, arrangement and visual effects displayed on the monitor 11 are exemplary embodiments and may be changed or modified without departing from the scope of the invention.

Monitor 11 may display acquired images, overlays to images, text, buttons, icons etc. to interact with a user.

The virtual monitor system 1 may initially display a greeting, and accompanying sounds or speech, inviting a user to try the program and asking whether they are interested in a product being sold. The system of the present invention may also include a motion detection feature so that when a user passes in view of the camera 12, the system will invite the user to try the virtual monitor system 1.

Before the virtual monitor system 1 is used, the system must be calibrated for the specific input devices and output devices being used.

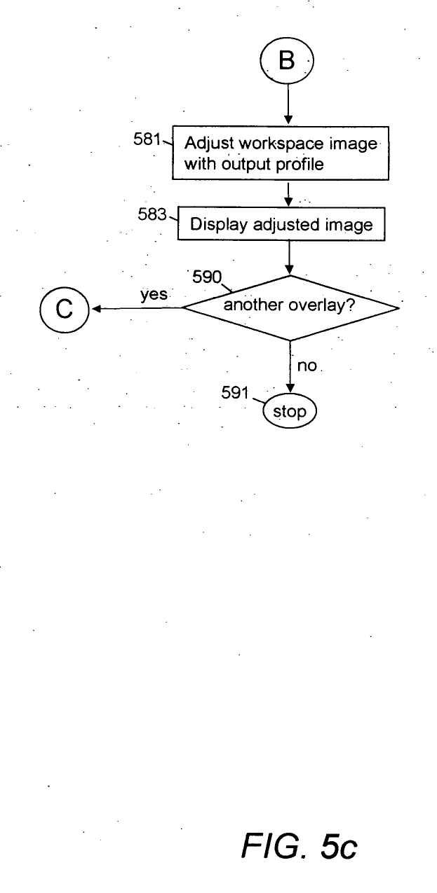

FIGS. 5a, 5b and 5c together show a flowchart of the operation of one embodiment of the virtual monitor system 1 according to the present invention. The functioning will be described here with reference to this flowchart and with reference to parts of the invention shown in FIG. 1,

Input Device Calibration

As described above, camera 12 distorts the spectrum of light passing through it. Also, as mentioned above, the ambient lighting has an effect upon the spectrum of the acquired image. Therefore, the room is dark and lights 35 and 37, specially designed to have the spectrum similar to that of daylight, are used as the sole source of light.

Since we're trying to determine how the camera sees light, we must calibrate the camera with a test pattern and an electronic representation of the spectra of each of the colors/locations on the test pattern. In step 501, a test pattern specially manufactured to have accurate colors at specific locations of the pattern is provided, along with a corresponding color-accurate electronic representation of the test pattern.

In step 503 the test pattern is placed a fixed distance from camera 12.

Camera 12 then acquires an image in step 505 by taking a picture of the test pattern. This image is stored in computer 10 as an electronic representation in computer 10 of spectra of each of the colors of the test pattern. Each location of the test pattern has a corresponding location on the acquired picture.

The electronic representation of the color at a location of the test pattern is compared to a corresponding location of the picture to determine the deviation in its color spectrum in step 507.

Step 507 is repeated for different locations/ colors of the test pattern and the acquired picture to result in a file describing the deviation in color due to the camera operating in the given light conditions. This is referred to as the ‘camera profile’. One such commonly available software product which may be used to determine the camera profile is MonacoDC Color™ by X-rite Photo Marketing. A more detailed description of this subject is provided in the “MonacoOPTIX^{XR}, Color Management Systems” publication by X-rite Photo Marketing, at the website http://www.xritephoto.com/product/DCcolor.com hereby incorporated by reference as if set forth in its entirety herein. A similar operation may be performed for other input devices such as a document scanner to determine the profiles of these input devices. Collectively these may be referred to as input profiles. These input profiles are specific not only to the type and model of input device used, but are specific to the input device itself This is because manufacturing differences and changes over time may cause lenses to become discolored, scratched, tinted and photo sensors may alter their sensitivity spectrum.

This input calibration must be performed whenever there is a change in performance, such as when a new camera is used, different lenses or filters are used, or the performance of the camera is otherwise changed. It is recommended that this calibration be performed when there is a noticeable difference in the color accuracy of the display.

A more complete description of the determination of an input profile is provided at the website http://www.xritephoto.com/product/dccolor/ hereby incorporated by reference as if set forth in its entirety herein.

Image Acquisition

In step 509, the user 2, stands in front of the camera at a specific distance and interacts with touch screen monitor 11 or keyboard 31 and mouse 33 to select an icon displayed on monitor 11 causing an image to be acquired of user 2. This may include various prompts either visual on monitor 11, or audible music, or voice instructing the user. An image is then acquired by the camera 12 and transferred to computer 10. One such piece of software which would function is the Breeze Camera Control application.

Image Adjustment

The input profile of step 507 defines the color deviation of the acquired image from the actual objects. The actual color representation of the image may be corrected in step 511 using the input profile of step 507 to correct the effects introduced by the input device and the ambient lighting. The adjusted image is now defined to have a ‘workspace profile’. One such software product which will perform such correction is Adobe Photoshop, however others may be employed.

Overlay Selection

In step 520 the user is asked to select a feature of their image which they would like to modify. In the Referenced Application, the user selected different colored contact lenses which essentially changed the color of their eyes. An overlay was constructed which covered the irises of the user's eyes in the image, and the color of the overlays were interactively chosen.

The present application will perform this function in a more color-accurate manner. In addition, the present application allows for the user to select and change the color of other features of their image such as lip color, hair color, skin tone, blemishes, apparel, etc. and combinations of the above.

One such method of selecting the overlay of step 520 would be to provide a message to the user indicating a menu of features to be changed, with choices being, for example, lip color, hair color, skin color, eye color, etc. in step 521.

Next, the user should choose a general area containing the feature in step 523.

The user is prompted to select a point inside of the feature in the chosen area in step 525.

In step 527 the computer determines a color characteristic which will be used to determine the extent of the feature, such as hue of the selected point, searches for, and selects connected pixels having the same hue, or connected pixels having a hue within a small range of the hue of the selected point.

In step 529, the collection of all selected pixels would be highlighted to the user allowing the user to select this feature, modify it or start over again.

In step 531 a mask or overlay is constructed which has the same size and shape of the selected feature, which will be colored to overlay the selected feature.

Alternatively, in step 520, a pre-defined overlay may be selected, such as for the iris of user 2's eyes.

Processing continues on FIG. 5b at the top marked “A”. After user 2 has selected the feature, user 2 then selects a color for the overlay in step 540.

In step 540 user 2 may simply use mouse 33 driving a cursor on monitor 11 to select an approximate color from a color palate displayed on the screen. User 2 may also select any point on the image being displayed.

Alternately, in step 541 user 2 may select an icon on monitor 11 indicating that he/she would like to acquire another image from an input device. In this case, a picture may be scanned by a scanner 41, or taken by camera 12 in step 543. Each of these images is also corrected in step 545 by the appropriate corresponding input profile as described above.

The resulting image is then displayed on a portion of the screen allowing user 2 in step 547 wherein user 2 selects an approximate color on the second image in step 549.

The overlays are merged into the workspace image in step 551. Adobe Photoshop may be used to merge these.

The output profile of output devices is determined in step 560. For example, if the output device, monitor 11 is a cathode ray tube display, the process is as follows.

Correction for Color Inaccuracy of the Monitor

Computer 10 is loaded with an electronic file of known accurate colors which will be displayed on the output device in step 561. A colorimeter device is placed on the screen of monitor 11 and accurately detects a color spectrum in step 563. The calorimeter has been pre-calibrated and is designed to function on a general purpose computer, such as computer 10.

Computer 10 repeats steps 561-563 for various colors/frequencies across the visible spectrum in step 565. The error introduced by the CRT monitor during display of the color is measured and stored in step 567 as an output profile.

Profiles may also be performed for other output devices, such as with an LCD monitor, plasma displays and printers, which shall be collectively referred to as “output profiles”.

MonacoOPTIXXR™ software from X-rite Photo Marketing is designed to profile monitor 11's output.

After step 567 of FIG. 5b, processing continues at the top of FIG. 5c where it is marked “B”. The output profile is used to adjust the image file prior to display in step 581.

The adjusted image is then displayed on monitor 11 in step 583.

In step 590, it is determined if the user would like to create any other overlays. If “no”, then the process stops at step 591. If the answer to step 590 is “yes”, then processing continues at step 521 at the location marked “C” in FIG. 5a. This allows the user to colorize other features, such as hair color, complexion, etc.

The present invention would also allow user 2 to select regions of skin, such as above the eyes and allow colors to gradually fade away in a given direction, to provide shading.

A use of the present invention would be to select all regions which appear to be skin tones, and to make them several shades darker, simulating a tan. This would be useful in selling tanning services.

Another use of the present invention would be to select regions of one's own skin which they prefer the color. The user may then virtually “brush on” the color to cover blemishes.

The color-accurate representation may be sent to a cosmetic manufacturer to have custom shades of makeup made. If connected to the internet the order may be sent immediately.

Once selected, these custom colors may be used to create custom makeup, or custom colored apparel.

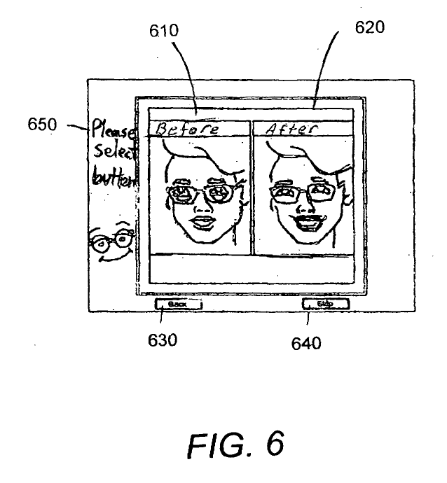

The present invention is also capable of saving the images created and displaying them side-by-side. FIG. 6 a screen shot of monitor 11 is shown having two images 610 and 620 of user 2 displayed side by side. The present invention is capable of saving and displaying numerous images, which may be the original image and/or those that have been enhanced with one or more colored overlays as described above.

FIG. 6 also shows ‘before’ and ‘after’ images of a user with different color lipstick. It also shows software buttons 630, 640 which, when clicked, cause the system to perform specified actions allowing the user to interact with the system. An instructional message 650 is shown on the left providing instructions to interact with user 2.

Contact Lenses/Eyeglasses

The present invention has many uses, for example as stated above, it is useful in assisting customers select eyeglass frames, colorized contact lenses, and/or opaque novelty contact lenses, as set forth in U.S. patent application Ser. No. 10/938,868 “Method of Interactive System for Previewing and Selecting Eyeware” by Dr. Michael R. Neal filed Sep. 13, 2004 referred to in “Cross Reference to Related Applications” above, (the “Referenced Application”) and hereby incorporated by reference as if it were included at length in the body herein.

The Referenced Application describes a system which is used to allow patients to interactively select colorized contact lenses and view a virtual image of themselves wearing these selected lenses. Since many times the contact lens or eyeglass the patient is currently wearing does not have the proper prescription, the patient is forced to evaluate these products while his vision is impaired. Thus, the customer is unable to view his or her own image accurately, and will often rely on an employee of the store in making their purchasing decision.

Therefore, the systems described above, and other embodiments of the present invention depend upon accurate representation of the image including color accuracy.

Cosmetics

An example would be an embodiment intended to be used at a cosmetic counter. A customer would like to determine which shade of lipstick would best match her complexion. This typically would require trying on lipstick and viewing the result in the mirror. The lipstick would have to be removed, and the process repeated for the next color. This process either produces significant waste “test” products, or incurs the potential for transfer of diseases from one customer to another. It also requires significant input from the employees asking them which would look better since one must simply remember the previous colors.

The present invention will quickly and accurately provide a virtual image of the user and allow her to select different colors of lipstick and interactively view the results.

Apparel

The present invention may be used to color-coordinate clothes, hats and other apparel. It would allow one to quickly and accurately change the colors of clothing, and display images simultaneously to do a side-by-side comparison. This allows a customer to try on many different color combinations in a short period of time. Once selected, the customer needs to only try on the clothes to select the proper size.

Since the present invention will allow the colors of many features to be adjusted simultaneously, a user may color-coordinate colors of clothes with the proper colors of makeup, hair color, contact lens color, etc. to coordinate the entire look without actually changing anything on the user.

Having thus described the invention, what is desired to be protected by Letters Patent is presented in the subsequently appended claims.

What is claimed is:

1. A method of providing a color accurate enhanced image of a user comprising the steps of:
a) determining an input profile [510] of an input device intended to be used indicating the color distortion of the input device;
b) determining an input correction profile from the input profile;
c) acquiring an image [509] with an input device;
d) modifying the color spectra of the input image [511] to create a workspace image by applying the input correction profile to at least one location of the image;
e) interacting with the user to select at least one virtual product, to select colors of the virtual product to create an overlay [520];
f) merging the overlay into the acquired image [551];
g) determining an output profile [560] of an output device intended to display the workspace image;
h) creating an output correction profile [581] from the output profile;
i) modifying the spectrum of the image and overlays [581] with the output correction profile to result in an adjusted image; and
j) displaying the adjusted image [583] through the output device to result in an image showing virtual products with substantially improved color accuracy.

2. The method of claim 1, wherein the step of determining an input correction profile comprises the steps of:
a) providing a test pattern [501] of colors having known color spectrum at known test pattern locations,
b) acquiring an image of the test pattern [505], the image having a plurality of image locations each corresponding to a test pattern location;
c) selecting a location of the test pattern and its color spectrum at that location;
d) measuring a color spectrum of the image location corresponding to the selected test pattern location;
e) comparing spectrum [507] of the test pattern at the selected test pattern location to the measured spectrum of the image at the image location to determine a portion of an input profile;
f) repeating steps “c”-“e” [507] for a plurality of test pattern locations to result in an input correction profile.

3. The method of claim 1 wherein the step of interacting with the user to select at least one virtual product comprises the steps of:
a) displaying a virtual product to said user [521];
b) having the user select a virtual product [525, 527]; and
c) creating an overlay [531] which pertains to the selected virtual product.

4. The method of claim 1 wherein the step of determining an output profile [560] comprises the steps of:
a) displaying a known color [561] at a specified location on an output device;
b) measuring the displayed color [563] of the specified location of the output device:
c) repeating steps “a”-“b” [565] for a plurality of different colors to create a measured color spectrum;
d) comparing the known color spectrum to the measured color spectrum [567] for the specified location to determine color error spectrum at the specified location;
e) repeating steps “a”-“d” for a plurality of specified locations [567] to result in a plurality of corresponding color error spectra referred to as an output profile for this output device.

5. The method of claim 1 wherein the step of interacting with the user to select overlays [520] wherein the selected overlay simulates at least one eyewear product.

6. The method of claim 1 wherein the step of interacting with the user to select overlays [520] wherein the selected overlay simulates at least one cosmetic product.

7. The method of claim 1 wherein the step of interacting with the user to select overlays [520] wherein the selected overlay simulates at least one article of clothing.

8. The method of claim 1 wherein the step of interacting with the user to select overlays [520] wherein the selected overlay simulates different skin tone.

9. The method of claim 1 wherein the step of interacting with the user to select overlays [520] wherein the selected overlay simulates different hair color.

10. The method of claim 1 further comprising the step of:
select lighting with a known color spectrum.

11. The method of claim 1 further comprising the step of:
manufacturing the selected virtual product with the selected colors.

12. The method of claim 1 further comprising the step of:
a) interacting with said user to select shading effects to the virtual product; and
b) merging the selected shading into the acquired image.

13. A virtual monitor system for displaying color corrected images of a user wearing virtual products, comprising:
a) an input device [12] for acquiring an image of said user;
b) a computer [10] functioning as a color correction unit;
c) an interactive product selection unit [11, 31, 33] allowing said user to select a virtual product to wear;
d) an output device [11, 51] for displaying images provided to it;
e) a computer [10] adapted to:
i. merge the virtual product over the acquired image of the user,
ii. calculate an output profile specifically for the output device, and
iii. provide the image and the output profile to the output device causing it to display a color corrected image to the user showing the user wearing said virtual products.

14. The virtual monitor system of claim 13 wherein the output device is a computer display screen [11].

15. The virtual monitor system of claim 13 wherein the output device is a device for printing [51].

16. The virtual monitor system of claim 13 further comprising:
a lighting source designed to have a known color spectrum.

17. The virtual monitor system of claim 13 wherein the virtual product is an eyewear product.

16. The virtual monitor system of claim 13 wherein the virtual product is a cosmetic product.

17. The virtual monitor system of claim 13 wherein the virtual product is an article of clothing.

18. The virtual monitor system of claim 13 wherein the virtual product simulates a skin tone different than that of the user.

19. The virtual monitor system of claim 13 wherein the virtual product simulates a hair color different than that of the user.

20. The virtual monitor system of claim 13 wherein the input device [12] and the computer [10] are adapted to detect motion and activate the system.
